(19) United States
(12) Patent Application Publication
(10) Pub. No.: US 2025/0331971 A1
(43) Pub. Date: Oct. 30, 2025

(54) DOUBLE-TANK ORAL IRRIGATOR

(71) Applicant: Ningbo Seago Electric Co., LTD., Ningbo City (CN)

(72) Inventors: Weibing Peng, Ningbo City (CN); Yanzhong Cai, Ningbo City (CN)

(21) Appl. No.: 19/023,481

(22) Filed: Jan. 16, 2025

(30) Foreign Application Priority Data
Apr. 28, 2024 (CN) 202410528716.2

(51) Int. Cl. A61C 17/024

(52) U.S. Cl. CPC A61C 17/024

(57) ABSTRACT

The present disclosure provides a double-tank oral irrigator. The double-tank oral irrigator includes a rotary valve, a first tank, a second tank, a water guide pipe, and a pump assembly. The rotary valve includes an outlet part, a first inlet part, a second inlet part, and a valve core. The rotation of the valve core enables adjustment of the sealing degree of the valve core to the first inlet part and the second inlet part. The first inlet part is connected to the first tank, the second inlet part is connected to the second tank, and one end of the water guide pipe is connected to the outlet part. The pump assembly is connected to the other end of the water guide pipe and a spray outlet of the oral irrigator.

### CROSS-REFERENCES TO RELATED APPLICATIONS

The present disclosure claims priority to Chinese Patent Application No. 2024105287162, entitled “DOUBLE-TANK ORAL IRRIGATOR” filed on Apr. 28, 2024 with the Chinese Patent Office, the entire contents of which are incorporated herein by reference.

### TECHNICAL FIELD

The present disclosure relates to the technical field of oral irrigators, and particularly to a double-tank oral irrigator.

### BACKGROUND ART

An oral irrigator is an auxiliary tool for cleaning the oral cavity, which uses pulsed water flow to clean teeth and interdental spaces. The primary function of mouthwash (rinsing agent) is to clean the oral cavity, mask bad breath caused by bacteria or yeast decomposing food residues, and leave a comfortable and refreshing feeling in the mouth. The functions of the two are complementary, and users often rinse with mouthwash after using an oral irrigator to clean their teeth. However, both the oral irrigator and mouthwash (typically bottled) occupy space, and their portability for travel needs improvement.

The patent with publication number CN213130038U discloses a double-tank oral irrigator, wherein two tanks and two water pipes are designed in the oral irrigator to allow the accommodation of different liquids, thus meeting user needs. However, it has a complex structure, and the water pipes occupy the larger space. The switching component for controlling liquid outflow causes wear on the water pipes, leaving room for improvement in stability and durability.

### SUMMARY

To solve or mitigate at least one problem mentioned in the background art, the present disclosure provides a double-tank oral irrigator.

The double-tank oral irrigator, provided in the embodiments of the present disclosure, includes
a rotary valve, wherein the rotary valve includes an outlet part, a first inlet part, a second inlet part, and a valve core, and a rotation of the valve core enables adjustment of a sealing degree of the valve core to the first inlet part and the second inlet part;
a first tank, wherein the first inlet part is connected to the first tank;
a second tank, wherein the second inlet part is connected to the second tank;
a water guide pipe, wherein one end of the water guide pipe is connected to the outlet part; and
a pump assembly, wherein the pump assembly is connected to the other end of the water guide pipe and a spray outlet of the oral irrigator.

In at least one embodiment, the rotary valve includes a valve body; the valve body comprises a main part and three parts including the first inlet part, the second inlet part, and the outlet part extending from the main part; the first inlet part and the second inlet part are located on a circumferential surface of the main part, and the first inlet part and the second inlet part are located at a same position in a circumferential direction of the main part and arranged side by side in an axial direction; and the valve core includes a first sealing part and a second sealing part arranged on the circumferential surface thereof, wherein the first sealing part is configured to block the first inlet part, the second sealing part is configured to block the second inlet part, and the first sealing part and the second sealing part are staggered in both the circumferential direction and the axial direction of the circumferential surface of the valve core, such that the valve core is only capable of selectively and completely blocking one of the first inlet part or the second inlet part.

In at least one embodiment, the first sealing part and the second sealing part are spaced apart by 60° to 120° in the circumferential direction of the circumferential surface of the valve core. The valve core is capable of simultaneously blocking a part of an interface space between the first inlet part and the main part and a part of an interface space between the second inlet part and the main part, allowing the outlet part to simultaneously receive liquid from the first tank and liquid from the second tank.

In at least one embodiment, the first inlet part and the second inlet part are located at a bottom of the valve body.

In at least one embodiment, the first sealing part and the second sealing part include silicone.

In at least one embodiment, the valve core is provided with shaft shoulders at both ends of the axial direction, and the shaft shoulders abut against an inner wall surface of the main part, ensuring that an axis of the valve core coincides with an axis of the main part.

In at least one embodiment, an end part of the valve core is connected to a hand wheel.

In at least one embodiment, the pump assembly includes a pressure chamber. One end of the pressure chamber is connected to the water guide pipe, and introduces liquid from the rotary valve into the pressure chamber. A first one-way valve is arranged between the water guide pipe and the pressure chamber.

The other end of the pressure chamber is connected to the spray outlet and allows the liquid in the pressure chamber to eject out of the oral irrigator through the spray outlet. A second one-way valve is arranged between the pressure chamber and the spray outlet.

In at least one embodiment, the pump assembly includes:
a gear shaft;
an eccentric shaft sleeve, wherein the eccentric shaft sleeve is fixedly connected to the gear shaft; and
a transmission rod, wherein one end of the transmission rod is sleeved on the eccentric shaft sleeve; the other end of the transmission rod is connected to a separator; and the separator forms as one surface of the pressure chamber.

In at least one embodiment, the first tank and the second tank are respectively provided with replenishment ports.

In the embodiments of the present disclosure, the first tank can store oral irrigator water, and the second tank can store mouthwash. The user can achieve liquid selection by controlling the rotary valve, such as using mouthwash for rinsing after oral irrigation, which offers high portability. The present disclosure uses a single water guide pipe instead of two water pipes (water guide pipes) as in the background art, allowing for a relatively simpler structure and more reasonable space allocation.

### BRIEF DESCRIPTION OF DRAWINGS

FIG. 1 illustrates a front view of a double-tank oral irrigator according to the embodiment of the present disclosure;

FIG. 2 illustrates a side view of a double-tank oral irrigator according to the embodiment of the present disclosure;

FIG. 3 illustrates a sectional view of a double-tank oral irrigator according to the embodiment of the present disclosure;

FIG. 4 illustrates a schematic structural diagram of a first tank and a second tank of a double-tank oral irrigator according to the embodiment of the present disclosure;

FIG. 5 illustrates a schematic structural diagram of a pump assembly of a double-tank oral irrigator according to the embodiment of the present disclosure;

FIG. 6 illustrates a partially enlarged view of a double-tank oral irrigator shown in FIG. 3;

FIG. 7 illustrates a schematic structural diagram of a rotary valve for an oral irrigator according to the embodiment of the present disclosure;

FIG. 8 illustrates a sectional view of a rotary valve for an oral irrigator according to the embodiment of the present disclosure; and

FIG. 9 illustrates a schematic structural diagram of a valve core in a rotary valve for an oral irrigator according to the embodiment of the present disclosure.

### REFERENCE NUMERALS

100 rotary valve; 110 outlet part; 120 first inlet part; 130 second inlet part; 140 valve body; 141 main part; 150 valve core; 151 first sealing part; 152 second sealing part; 153 shaft shoulder; 154 hand wheel;

210 first tank; 211 first replenishment port; 220 second tank; 221 second replenishment port;

300 water guide pipe;

400 pump assembly; 410 pressure chamber; 411 first one-way valve; 412 second one-way valve; 420 gear shaft; 421 gear; 430 eccentric shaft sleeve; 440 transmission rod; 450 separator; 460 transmission gear;

500 spray outlet; 510 nozzle;

610 battery; 620 motor.

### DETAILED DESCRIPTION OF EMBODIMENTS

The exemplary embodiments of the present disclosure are described below with reference to the drawings. It should be understood that these specific descriptions are only provided to instruct those skilled in the art on how to implement the present disclosure and are not intended to exhaust all possible implementations of the present disclosure, nor to limit the scope of the present disclosure.

The embodiments of the present disclosure provide a double-tank oral irrigator (hereinafter sometimes simply referred to as “oral irrigator”).

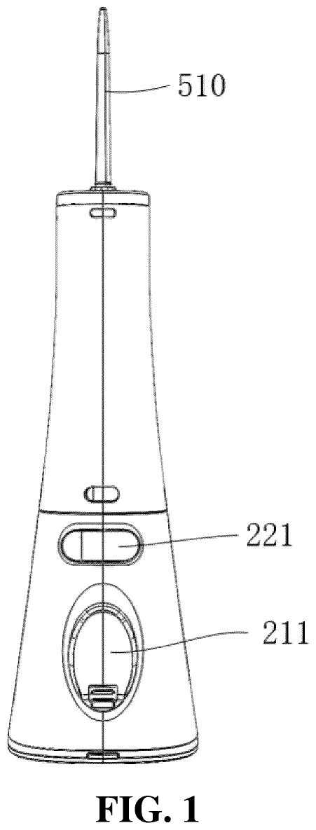

Referring to FIGS. 1 to 6, the double-tank oral irrigator can include a rotary valve 100, a first tank 210, a second tank 220, a water guide pipe 300, and a pump assembly 400.

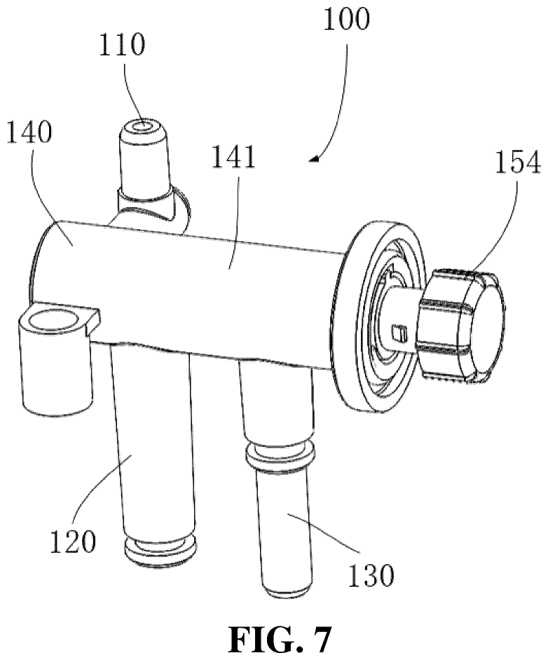

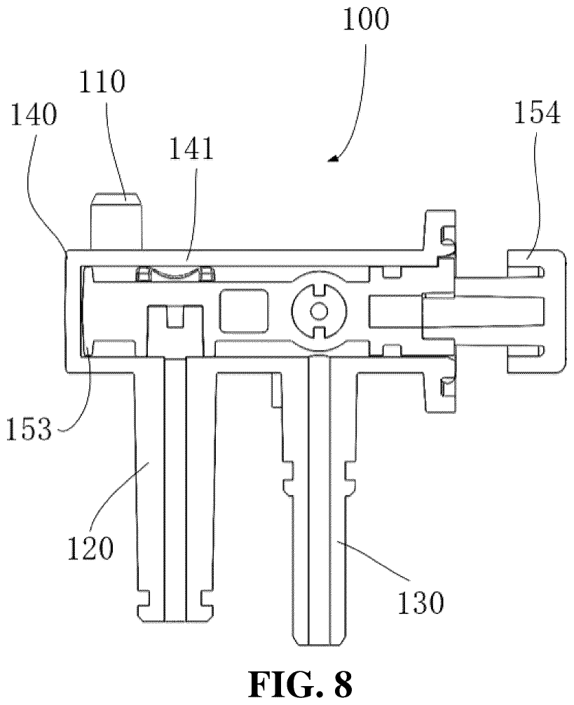

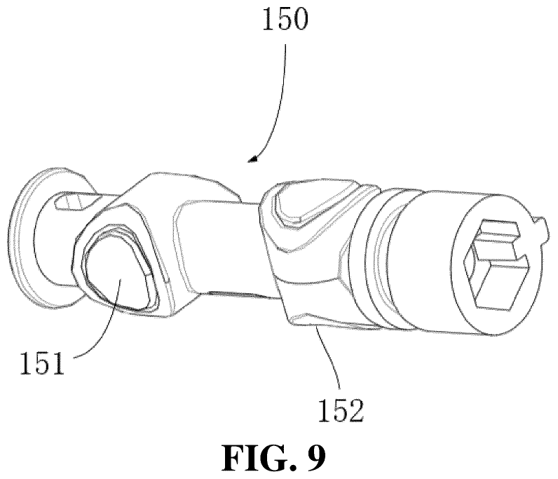

Referring to FIG. 7, FIG. 8, and FIG. 9, the rotary valve 100 can include an outlet part 110, a first inlet part 120, a second inlet part 130, a valve body 140, and a valve core 150. By rotating the valve core 150, the sealing degree of the valve core 150 to the first inlet part 120 and the second inlet part 130 can be adjusted, thereby enabling the selection of the liquid source flowing through the rotary valve 100.

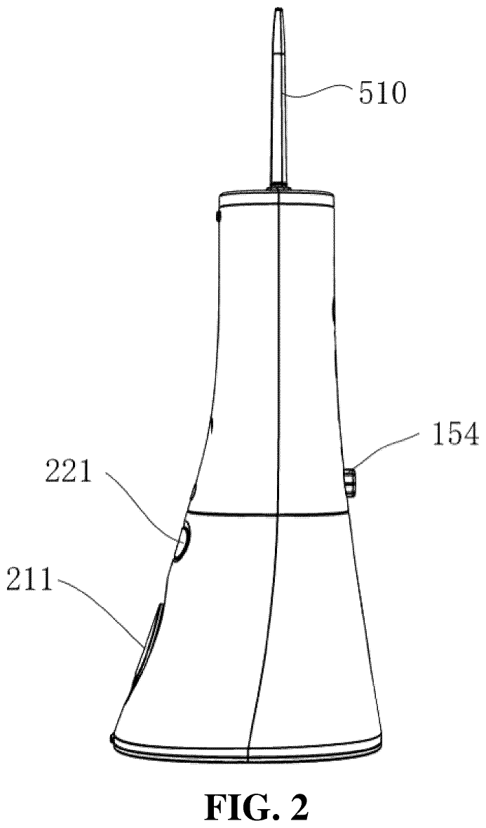

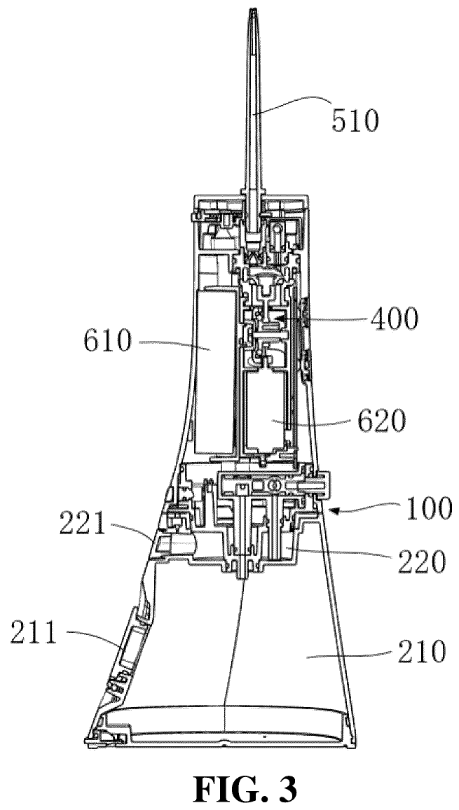

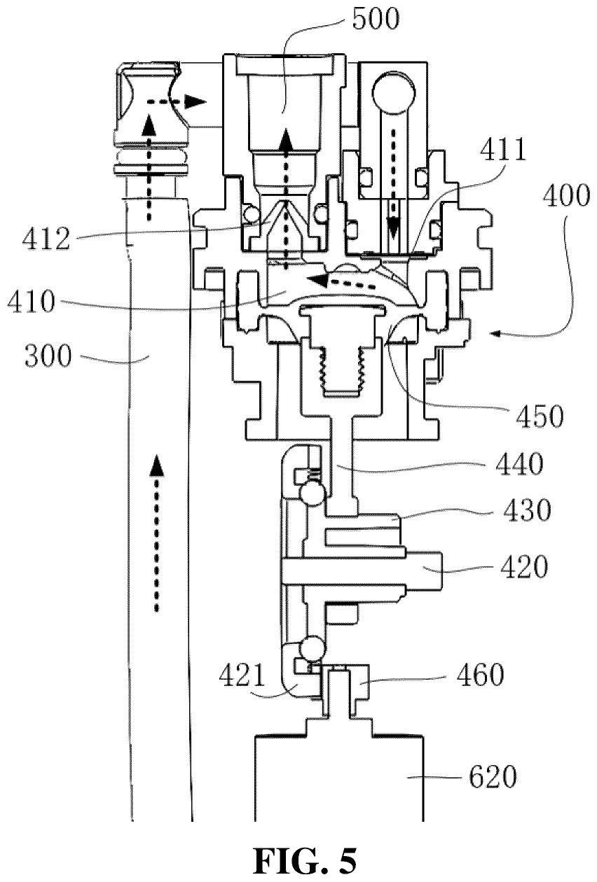

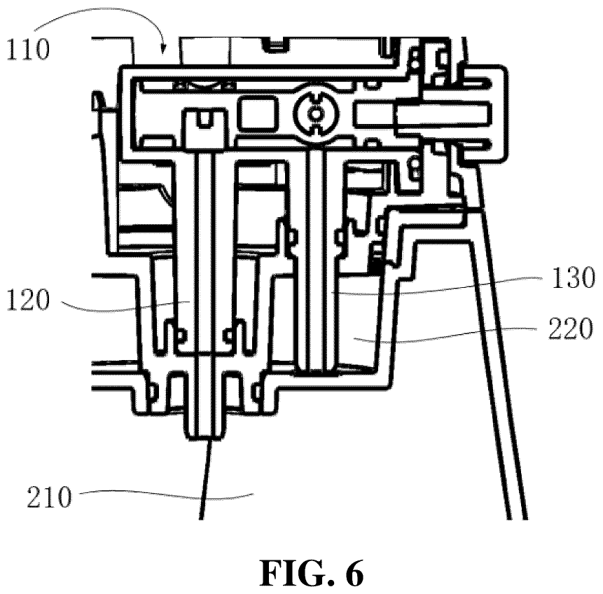

Referring to FIG. 6, the first inlet part 120 is connected to the first tank 210; the second inlet part 130 is connected to the second tank 220; and one end of the water guide pipe 300 is connected to the outlet part 110. Referring to FIG. 5, the pump assembly 400 is connected to the other end of the water guide pipe 300 and the spray outlet 500 of the oral irrigator. A nozzle 510 can also be arranged outside the spray outlet 500 (referring to FIG. 1, FIG. 2, and FIG. 3).

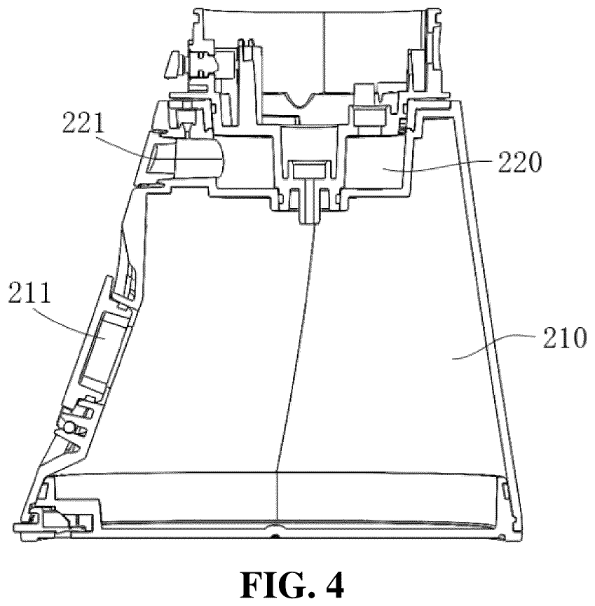

As shown by the dashed arrows in FIG. 5, liquid can flow through the water guide pipe 300 and the pump assembly 400 and be sprayed out from the spray outlet 500. Referring to FIG. 4, the first tank 210 can store oral irrigation water (e.g., clear water), and the second tank 220 can store mouthwash (e.g., rinsing agent). The volume of the first tank 210 can be larger than the volume of the second tank 220.

It can be understood that the present disclosure applies the rotary valve 100 to the oral irrigator, simplifying the liquid switching process. The user can adjust the rotary valve 100 after completing oral irrigation with the irrigation water, allowing the oral irrigator to spray mouthwash for rinsing. This eliminates the need to separately carry two products of the oral irrigator and a mouthwash bottle, providing enhanced portability. The present disclosure uses a single water guide pipe 300 instead of two water pipes (water guide pipes) as in the background art, allowing for a relatively simpler structure and more reasonable space allocation. The workstation switching process of the rotary valve 100 does not wear the water guide pipe 300, ensuring that the oral irrigator is sturdy and durable.

According to one embodiment of the present disclosure, with reference to FIGS. 6 to 9, the valve body 140 can include a main part 141 and three parts including the first inlet part 120, the second inlet part 130, and the outlet part 110 extending from the main part 141. The first inlet part 120 and the second inlet part 130 are located at a same position in a circumferential direction of the main part 141 and arranged side by side in an axial direction. The valve core 150 comprises a first sealing part 151 and a second sealing part 152 arranged on the circumferential surface thereof, wherein the first sealing part 151 is configured to block the first inlet part 120, and the second sealing part 152 is configured to block the second inlet part 130.

The first sealing part 151 and the second sealing part 152 are staggered in both the circumferential direction and the axial direction of the circumferential surface of the valve core 150, such that only one of the first inlet part 120 and the second inlet part 130 can be completely blocked by the valve core 150. For example, the communication relationship in the rotary valve 100 can include the following. When the first sealing part 151 blocks the first inlet part 120, the outlet part 110 can communicate with the second inlet part 130. When the second sealing part 152 blocks the second inlet part 130, the outlet part 110 can communicate with the first inlet part 120. When neither inlet part is completely blocked (as described later), the outlet part 110 can simultaneously communicate with both the first inlet part 120 and the second inlet part 130.

In one embodiment of the present disclosure, referring to FIG. 6 to FIG. 9, the first sealing part 151 and the second sealing part 152 are spaced apart by 60° to 120° in the circumferential direction of the circumferential surface of the valve core 150, such as a difference of 90°. The valve core 150 is capable of simultaneously blocking a part of an interface region between the first inlet part 120 and the main part 141 and a part of an interface region between the second inlet part 130 and the main part 141, enabling the liquid from the first inlet part 120 and the liquid from the second inlet part 130 to enter the valve body 140 simultaneously. This allows the outlet part 110 to simultaneously communicate with the first inlet part 120 and the second inlet part 130 by controlling the rotation angle of the valve core 150, enabling the user to control the liquid spray ratio as needed.

For example, the interface between the first inlet part 120 and the main part 141 can be blocked by 20% by the valve core 150, and the interface between the second inlet part 130 and the main part 141 can be blocked by 80% by the valve core 150. Thus, the liquid (clean water) in the first tank 210 accounts for 80% of the liquid sprayed by the oral irrigator, and the liquid (mouthwash) in the second tank 220 accounts for 20% of the liquid sprayed by the oral irrigator. Therefore, the high-concentration mouthwash can be filled into the second water tank 220. During use, the liquid ratio can be controlled to dilute the mouthwash with clear water to the appropriate concentration, thus reducing the frequency of replenishing the mouthwash in the second tank, better meeting user needs, and increasing user retention.

The valve core 150 can be manually rotated or controlled to rotate via a motor. The motor controller can be communicated with an application program on the mobile terminal of users, allowing the users to customize the liquid mixing ratio. The motor drives the valve core 150 to rotate by the corresponding angle to achieve the desired mixing ratio.

In one embodiment of the present disclosure, referring to FIG. 8, the first inlet part 120 and the second inlet part 130 are located at the bottom of the valve body 140. The first inlet part 120 and the second inlet part 130 are both located at the bottom, which facilitates the mounting of the rotary valve 100, such as by vertically inserting it into the corresponding interface of the tank, thus providing a simple structure and convenient mounting. The interface of the outlet part 110 configured for connecting the water guide pipe 300 can be oriented upward, facilitating its connection to the water guide pipe 300.

In one embodiment of the present disclosure, referring to FIG. 8, the interior cavity of the main part 141 can be cylindrical, and the valve core 150 is provided with shaft shoulders 153 at both ends of the axial direction. The shaft shoulders 153 abut against an inner wall surface of the main part 141, which ensures that an axis of the valve core 150 coincides with an axis of the main part 141, and is convenient for the sealing part to seal the corresponding inlet part smoothly.

In one embodiment of the present disclosure, the first sealing part 151 and the second sealing part 152 can include or be made of silicone rubber. Of course, they may also be made of other materials, such as other types of soft materials, as long as they can achieve the sealing function.

In one embodiment of the present disclosure, referring to FIG. 7 and FIG. 8, the end part of the valve core 150 is connected to a hand wheel 154. The rotation of the valve core 150 is controlled by the hand wheel 154 to facilitate controlling the opening and closing of the corresponding liquid. The hand wheel 154 can be provided with a rotational angle limit structure of the hand wheel 154, such as providing the clockwise rotation limit of the hand wheel 154 to completely block the first inlet part 120, and providing the counterclockwise rotation limit to completely block the second inlet part 130. The rotational angle limit structure can include an arcuate track, with the hand wheel 154 connected to the valve core through a connecting rod. A movable block is arranged on the connecting rod, and the movable block is arranged in the track. The position of the moving block is limited by the arcuate track to limit the rotation angle of the hand wheel 154.

In one embodiment of the present disclosure, referring to FIG. 5, the pump assembly 400 can include a pressure chamber 410. One end of the pressure chamber 410 (for example, the upper-right end of the pressure chamber 410 in FIG. 5) is connected to the water guide pipe 300, introducing the liquid from the rotary valve 100 into the pressure chamber 410. The other end of the pressure chamber (for example, the upper-left end of the pressure chamber 410 in FIG. 5) is connected to the spray outlet 500, causing the liquid in the pressure chamber 410 to spray out of the oral irrigator through the spray outlet 500.

In one embodiment of the present disclosure, referring to FIG. 5, a first one-way valve 411 is arranged between the water guide pipe 300 and the pressure chamber 410, and a second one-way valve 412 is arranged between the pressure chamber 410 and the spray outlet 500. The second one-way valve 412 can be a duckbill valve.

In one embodiment of the present disclosure, referring to FIG. 3, the double-tank oral irrigator can include a battery 610 and a motor 620. The battery 610 is connected to the motor 620, and the output shaft of the motor 620 is connected to the pump assembly 400 to drive the liquid pumping.

In one embodiment of the present disclosure, referring to FIG. 5, the pump assembly 400 can include a gear shaft 420, an eccentric shaft sleeve 430, and a transmission rod 440. The eccentric shaft sleeve 430 is fixedly connected to the gear shaft 420. One end of the transmission rod 440 is sleeved on the eccentric shaft sleeve 430; the other end of the transmission rod is connected to a separator 450; and the separator 450 forms as one surface of the pressure chamber 410. Its working principle can be as follows. The gear shaft 420 is driven by the motor 620 to drive the eccentric shaft sleeve 430 to rotate, and the transmission rod 440 forms a cam mechanism with the eccentric shaft sleeve 430 to drive the transmission rod 440 to reciprocate. When the transmission rod 440 moves upward, the liquid in the pressure chamber 410 is pumped out through the spray outlet 500. When the transmission rod 440 moves downward, the liquid in the first tank 210 or the second tank 220 is pumped into the pressure chamber 410.

Furthermore, the pump assembly 400 can include a transmission gear 460, the output shaft of the motor 620 is connected to the transmission gear 460, and the transmission gear 460 engages with the gear 421 of the gear shaft 420 to drive the gear shaft 420 to rotate. The transmission gear 460 and the gear 421 of the gear shaft 420 can be bevel gears, and their axes intersect.

In one embodiment of the present disclosure, referring to FIG. 4, the side of the first water tank 210 is provided with a first replenishment port 211, and the side of the second water tank 220 is provided with a second replenishment port 221. Through each replenishment port, each tank can be replenished with the corresponding liquid.

In one embodiment of the present disclosure, referring to FIG. 4, the first tank 210 is located below the second tank 220.

The above-described is the preferred embodiment of the present disclosure. It should be noted that for those skilled in the art, several improvements and modifications can be made without departing from the principles of the present disclosure, and these improvements and modifications should also be regarded as falling within the scope of the present disclosure.

1. A double-tank oral irrigator, comprising:
a rotary valve, wherein the rotary valve comprises an outlet part, a first inlet part, a second inlet part, and a valve core, and a rotation of the valve core enables adjustment of a sealing degree of the valve core to the first inlet part and the second inlet part;
a first tank, wherein the first inlet part is connected to the first tank;
a second tank, wherein the second inlet part is connected to the second tank;
a water guide pipe, wherein one end of the water guide pipe is connected to the outlet part; and
a pump assembly, wherein the pump assembly is connected to the other end of the water guide pipe and a spray outlet of the oral irrigator.

2. The double-tank oral irrigator according to claim 1, wherein the rotary valve comprises a valve body; the valve body comprises a main part and three parts comprising the first inlet part, the second inlet part, and the outlet part extending from the main part; the first inlet part and the second inlet part are located on a circumferential surface of the main part, and the first inlet part and the second inlet part are located at a same position in a circumferential direction of the main part and arranged side by side in an axial direction; and
the valve core comprises a first sealing part and a second sealing part arranged on a circumferential surface thereof, wherein the first sealing part is configured to block the first inlet part, the second sealing part is configured to block the second inlet part, and the first sealing part and the second sealing part are staggered in both a circumferential direction and an axial direction of the circumferential surface of the valve core, such that the valve core is only capable of selectively and completely blocking one of the first inlet part (120) or the second inlet part.

3. The double-tank oral irrigator according to claim 2, wherein the first sealing part and the second sealing part are spaced apart by 60° to 120° in the circumferential direction of the circumferential surface of the valve core, and the valve core is capable of simultaneously blocking a part of an interface region between the first inlet part and the main part and a part of an interface region between the second inlet part and the main part, allowing the outlet part to simultaneously receive liquid from the first tank and liquid from the second tank.

4. The double-tank oral irrigator according to claim 2, wherein the first inlet part and the second inlet part are located at a bottom of the valve body.

5. The double-tank oral irrigator according to claim 2, wherein the first sealing part and the second sealing part comprise silicone.

6. The double-tank oral irrigator according to claim 2, wherein the valve core is provided with shaft shoulders at both ends of the axial direction, and the shaft shoulders abut against an inner wall surface of the main part, ensuring that an axis of the valve core coincides with an axis of the main part.

7. The double-tank oral irrigator according to claim 1, wherein an end part of the valve core is connected to a hand wheel.

8. The double-tank oral irrigator according to claim 1, wherein the pump assembly comprises a pressure chamber, wherein one end of the pressure chamber is connected to the water guide pipe, and introduces liquid from the rotary valve into the pressure chamber; a first one-way valve is arranged between the water guide pipe and the pressure chamber; and
the other end of the pressure chamber is connected to the spray outlet and allows the liquid in the pressure chamber to eject out of the oral irrigator through the spray outlet,
and a second one-way valve is arranged between the pressure chamber and the spray outlet.

9. The double-tank oral irrigator according to claim 8, wherein the pump assembly comprises:
a gear shaft;
an eccentric shaft sleeve, wherein the eccentric shaft sleeve is fixedly connected to the gear shaft; and
a transmission rod, wherein one end of the transmission rod is sleeved on the eccentric shaft sleeve; the other end of the transmission rod is connected to a separator; and the separator forms as one surface of the pressure chamber.

10. The double-tank oral irrigator according to claim 1, wherein the first tank and the second tank are respectively provided with replenishment ports.
